(19) United States
(12) Patent Application Publication
(10) Pub. No.: US 2007/0293157 A1
(43) Pub. Date: Dec. 20, 2007

(54) Mobile Assisted Timing Alignment

(75) Inventors: Jacobus Haartsen, Hardenberg (NL); Bengt Lindoff, Bjarred (SE)

Correspondence Address: POTOMAC PATENT GROUP PLLC, P. O. BOX 270, FREDERICKSBURG, VA, 22404, US

(73) Assignee: TELEFONAKTIEBOLAGET L M ERICSSON (PUBL), Stockholm (SE)

(21) Appl. No.: 11/425,324

(22) Filed: Jun. 20, 2006

(51) Int. Cl. H04B 17/00; H04B 15/00; H04B 7/00

(52) U.S. Cl. 455/67.11; 455/501

(57) ABSTRACT

Timing alignment of User Equipment (UE) in a communications system is maintained by measuring an environmental condition of the UE, and determining a present magnitude of change metric representing a present magnitude of change of the environmental condition relative to a baseline value. The present magnitude of change metric is combined with a previous accumulation metric to obtain a present accumulation metric. If it is detected that the present accumulation metric satisfies a predetermined relationship with respect to the threshold value (e.g., is greater than the threshold value), then the UE transmits a timing advance request. An environmental condition can be, for example, a Doppler shift of a received signal, a Received Signal Strength Indication from a received signal, a temperature within the UE, a humidity within the UE, a supply voltage of the UE, or a symbol timing of a received signal.

### BACKGROUND

The present invention relates to mobile telecommunication systems, and more particularly to methods and apparatuses that maintain timing synchronization between transceivers in a telecommunication system.

Digital communication systems include time-division multiple access (TDMA) systems, such as cellular radio telephone systems that comply with the GSM telecommunication standard and its enhancements like GSM/EDGE, and Code-Division Multiple Access (CDMA) systems, such as cellular radio telephone systems that comply with the IS-95 and cdma2000 telecommunication standards. Digital communication systems also include Wideband CDMA (WCDMA) telecommunication standards, such as cellular radio telephone systems that comply with the Universal Mobile Telecommunications System (UMTS) standard, which specifies a third generation (3G) mobile system being developed by the European Telecommunications Standards Institute (ETSI) within the International Telecommunication Union's (ITU's) IMT-2000 framework. The Third Generation Partnership Project (3GPP) promulgates the UMTS standard. An upgraded version of 3GPP, which is known as “UTRA-UTRAN Long Term Evolution (LTE)” (henceforth 3G LTE), is intended to provide technology that is ten to a hundred times faster than existing 3G services.

This application focuses on 3G LTE systems for economy of explanation, but it will be understood that the principles described in this application are relevant to, and can be implemented in other digital communication systems.

The specifications of 3G LTE are still under construction. However, the air interface is based on Orthogonal Frequency Division Multiple Access (OFDMA). In OFDMA, a resource consists of a time-frequency block. The frequency bandwidth and time duration can be changed dynamically, giving large flexibility of resource allocation among multiple users. In the uplink, a special form of OFDMA is proposed, namely pre-coded OFDMA, which has the benefit of a lower Peak-to-Average Power Ratio (PAPR) than pure OFDMA. In the time domain, sub-frames with a nominal duration of 0.5 ms have been defined. Each sub-frame contains a few OFDM symbols (including a cyclic prefix as a guard interval). The resource allocation from sub-frame to sub-frame may change dynamically. Since consecutive sub-frames may be allocated to different users, any overlap in time needs to be prevented as this will result in interference between users, in particular in the uplink (i.e., the direction from the user equipment (UE) to the base station). Therefore, the users need to be accurately time synchronized. Similar requirements are found in TDMA systems.

FIG. 1 depicts a mobile radio cellular telecommunication system 100, which may be, for example, a TDMA or a 3G LTE communication system. Radio network controllers (RNCs) 112, 114 control various radio network functions including for example radio access bearer setup, handover, and the like. More generally, each RNC directs UE calls via the appropriate base station(s) (BSs). For clarity, the RNCs are depicted as explicit entities, but it will be noted that their functionality may be distributed among the base stations. The UE and BS communicate with each other through downlink (i.e., base-to-UE or forward) and uplink (i.e., UE-to-base or reverse) channels. RNC 112 is shown coupled to BSs 116, 118, 120, and RNC 114 is shown coupled to BSs 122, 124, 126. Each BS serves a geographical area that can be divided into one or more cell(s). BS 126 is shown as having five antenna sectors S1-S5, which can be said to make up the cell of the BS 126. The BSs are coupled to their corresponding RNCs by dedicated telephone lines, optical fiber links, microwave links, and the like. Both RNCs 112, 114 are connected with external networks such as the public switched telephone network (PSTN), the Internet, and the like through one or more core network nodes like a mobile switching center (not shown) and/or a packet radio service node (not shown). In FIG. 1, UEs 128, 130 are shown communicating with plural base stations: UE 128 communicates with BSs 116, 118, 120, and UE 130 communicates with BSs 120, 122. A control link between RNCs 112, 114 permits diversity communications to/from UE 130 via BSs 120, 122.

At the UE, the modulated carrier signal (Layer 1) is processed to produce an estimate of the original information data stream intended for the receiver.

In a typical wireless communication system, each device (e.g. UE, BS) has its own local oscillator which defines a time reference. It is crucial that the local oscillators of devices communicating with each other be aligned as precisely as possible, otherwise their time references will drift in relation to each other. This drift could lead to the devices no longer being capable of receiving information properly from each other, which in turn causes degraded receiver performance. Moreover, time drift may cause consecutive sub-frames to overlap, resulting in interference between users.

The UE can obtain a coarse timing synchronization to the core network by receiving downlink channels, such as the Broadcast Control CHannel (BCCH). However, since the distance to the base station (also referred to as “Node B”) is unknown, there is an unknown delay between the transmission at Node B and the reception in the UE. The same delay will appear in the uplink. Therefore, there is a round-trip delay uncertainty. This round-trip delay is larger for UEs located at the cell edge than for units close to the Node B. For multiple access techniques that are based on time slots and for modulation techniques that apply a form of Orthogonal Frequency Division Multiplexing (OFDM), timing alignment of uplink transmissions is essential in order to avoid interference between user signals.

As part of controlling the timing of the individual UEs, the Node B measures the uplink timing from each UE relative to a timing reference. For this purpose, the UE must regularly transmit data in the uplink so that the Node B will have something to measure. If the timing of a UE is misaligned, the Node B sends a time alignment (TA) message to that UE to adjust its uplink timing. When the transmission arrives too late, Node B sends a TA message to the UE instructing it to advance its timing. When the burst arrives too early, Node B sends a TA message to the UE instructing it to delay its timing.

A guard time is required to provide some slack in the timing control. Initial uplink access bursts (AB), sent on the Physical Random Access Channel (PRACH), are relatively short in order to allow a sufficient guard period (GP) and avoid any overlap with preceding and following time slots. These unsynchronized ABs will therefore not interfere with user traffic. Once the UE is synchronized in the uplink direction, only a small GP is required between slots or sub-frames in a time-slotted system to account for drift and to reduce the number of TA messages in the downlink.

Over time, the timing alignment may change. This can be caused by changes in the round-trip delay time as a result of movement of the UE, or by mutual drift in the clocks used in the Node B and the UE. Normally, the clock in the Node B is very accurate and the drift is very low, typically on the order of 0.05 ppm. By contrast, the clock in the UE is less accurate. One reason for this is that the UE is subjected to stricter cost and power consumption requirements. In addition, the temperature varies more in the UE.

One of the things a UE does to save power while in a low-power mode is to avoid sending uplink transmissions too often. However, if the elapsed time between uplink transmissions becomes too long, the UE may lose uplink synchronization. In particular, when the UE moves or when environmental conditions change, the UE uplink transmission may become misaligned if the UE's uplink transmissions have been too infrequent. To prevent this, the Node B can instruct the UE to transmit dummy bursts in the uplink more frequently so that the Node B can perform measurements and return TA messages. However, this places a burden on the system and is a wasteful drain of power for those UEs that are experiencing stable conditions.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in methods and apparatuses for operating a User Equipment (UE). In one aspect, this includes measuring an environmental condition of the UE, and determining a present magnitude of change metric representing a present magnitude of change of the environmental condition relative to a baseline value. The present magnitude of change metric is combined with a previous accumulation metric to obtain a present accumulation metric. A test is then made to detect whether the present accumulation metric satisfies a predetermined relationship with respect to a threshold value. If it is detected that the present accumulation metric satisfies the predetermined relationship with respect to the threshold value, then a timing advance request is transmitted.

Any of a number of different environmental conditions can be used in various embodiments. For example, the environmental condition can be a Doppler shift of a received signal, a Received Signal Strength Indication from a received signal, a temperature within the UE, a humidity within the UE, a supply voltage of the UE, or a symbol timing of a received signal.

In another aspect, the baseline value can be determined differently for different types of environmental conditions. For example, when the environmental condition is Doppler shift, then the baseline value can be set to zero. As other examples, when the environmental condition is any one of a Received Signal Strength Indication from a received signal, a temperature within the UE, a humidity within the UE, a supply voltage of the UE, or a symbol timing of a received signal, then the baseline value is a value of the environmental condition determined when a most recent timing advance update was performed.

### BRIEF DESCRIPTION OF THE DRAWINGS

The objects and advantages of the invention will be understood by reading the following detailed description in conjunction with the drawings in which:

FIG. 1 depicts a mobile radio cellular telecommunication system 100, which may be, for example, a CDMA or a WCDMA communication system.

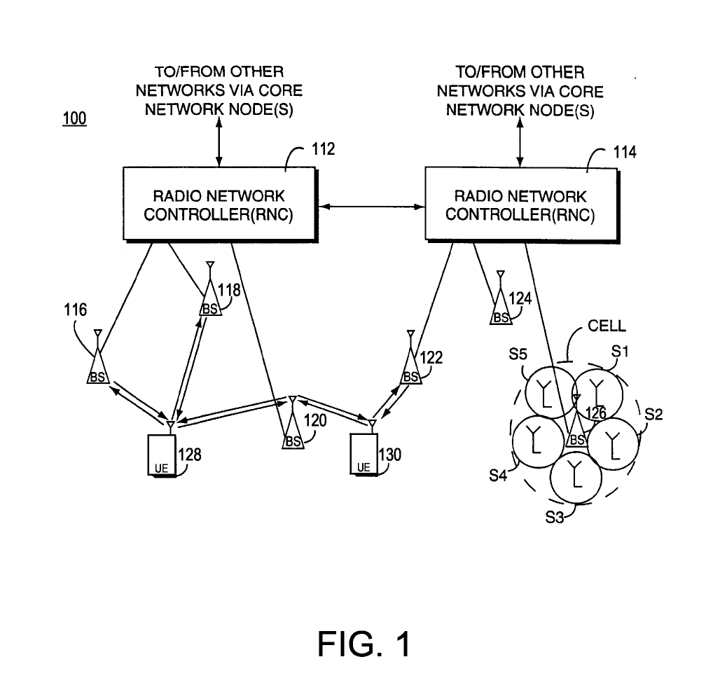

FIG. 2 is an exemplary embodiment of a method carried out in a UE in accordance with the invention.

FIG. 3 is a block diagram of an exemplary embodiment of a UE 300 adapted to practice the invention.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments may be referred to herein as “logic configured to” perform a described action, or alternatively as “logic that” performs a described action.

In one aspect of the invention, needless uplink transmissions (and the consequent expenditure of energy) are avoided by determining in what condition the UE is operating. If varying conditions are detected, then the UE will transmit an uplink message with a request for timing alignment. If conditions are stable, then the uplink transmission is unnecessary and can be avoided. In this way, the Node B is able to track the UE timing changes more accurately, and can send TA messages to compensate for the timing misalignment. Because this is done in response to detecting varying conditions at the UE, overhead in the system is minimized (as is loss of capacity) since frequent TA messages are sent to only those UEs in which the local conditions have changed. In addition, only those UEs that are likely to experience timing misalignment will dissipate the extra power associated with sending uplink messages more frequently.

In another aspect, any one or combination of different types of conditions can be monitored to detect relevant varying conditions. For UEs that are fast moving or accelerating, experience extreme temperature changes or changes in the humidity, or changes in the power supply, regular time alignment updates are required to avoid timing misalignment. For UEs under stable and stationary conditions, the needed rate for timing alignment updates is much lower. The UE's speed (derived from frequency shift due to Doppler effects and downlink timing adjustments) and acceleration can be determined based on measurements in the downlink signal reception. Variations in the downlink received signal strength indicate whether the line-of-sight conditions have changed into non-line-of-sight conditions, and vice versa. Sensors can measure (changes in) temperature, humidity, and power supply voltage.

These and other aspects of the various embodiments will now be described in greater detail.

The UE obtains downlink synchronization by tuning both in frequency and time to the received downlink transmissions. Usually, the frequency and timing synchronization of the uplink transmission is derived from the downlink transmission. However, since the distance d between the UE and the Node B is unknown, an uncertainty in the uplink timing remains which corresponds to twice the propagation delay. The propagation delay, ΔTₚ, depends on the distance d and the speed of light c, according to ΔTₚ=d/c. The round-trip delay of 2ΔTₚ amounts to 6.7 μs/km. Consequently, the uplink timing difference between the signal received from a UE that is close to the Node B and a UE located farther away at 15 km from the Node B amounts to 100 μs. Many systems, such as GSM/GPRS and the new cellular system 3G LTE currently under development, apply a time-slotted structure. To avoid time overlap, and therefore interference, between consecutive slots used by different UEs, the timing of the signals arriving at the Node B receiver needs to be aligned accurately. Therefore, the Node B constantly measures the timing of the signals. If the Node B detects a timing slip it instructs a corresponding UE to either retard or advance its timing, depending on circumstances. These messages are conveyed by means of special Layer 2 (L2) timing alignment messages.

In order for the Node B to have something to measure, the UE needs to send uplink transmissions. If the UE has a (circuit-switched) traffic connection on-going, sufficient uplink data will be present to carry out the measurements. However, if a packet-switch mode is being used with infrequent uplink transmissions (like in a GPRS system) or if the UE is in a low-power mode operating at a low duty cycle, there will not be many uplink transmissions. In such modes, the Node B periodically instructs the UE to send a dummy burst just so that it will have an uplink signal upon which it can perform a timing measurement. For example, in GSM/GPRS a special control channel is defined for the timing alignment: the Packet Timing Advance Control Channel (PTCCH). On this channel, a UE sends an access burst every 8 multi-frames (which in a GSM/GPRS is once every 1.92 s). Thereafter, the Node B may send a TA message to re-align the UE uplink timing. In the GSM/GPRS system, guard periods of 30 μs are used, so the TA interval can be a couple of seconds. For the new 3G LTE system, the guard period is much smaller, on the order of 1 μs. Therefore, the TA interval can only be a couple of hundred milliseconds or even smaller.

It will be understood that for UEs whose environmental conditions are rather stable the uplink timing will be correspondingly stable, so an interval of a couple of hundred milliseconds will be unnecessarily frequent. By contrast, UEs that are moving, or whose internal condition like temperature, humidity, power supply voltage, or any other parameter, is changing rapidly over time will benefit from more frequent timing updates. When the UE receives a TA message, the uplink timing is fairly accurate. The initial accuracy mainly depends on the Doppler shift (which in turn depends on the velocity of the UE). The uncertainty in the initial TA update increases due to a number of reasons, including: the elapsing of time (because of the drift of the UE clocks with respect to the Node B timing reference), motion of the UE, and changes in local conditions such as but not limited to temperature. All of these parameters, which affect the accuracy of the TA update (including the initial inaccuracy), can be determined in the UE. For example, the shift in received carrier frequency and symbol timing, as well as changes in the delay spread indicate acceleration and velocity; a sudden change in the Received Signal Strength Indication (RSSI) may indicate a change in the line-of-sight conditions; temperature sensors can measure a change in temperature. Based on such measured values of the UE's environmental conditions (e.g., velocity, acceleration, temperature, humidity, operating voltage, and the like), the UE can decide whether a new TA update needs to be made in order to keep the uplink timing sufficiently accurate (avoiding overlap). As used throughout this specification, including the claims, the term “environmental conditions” refers to those conditions that are capable of both remaining static during a time interval, and of changing during a time interval. Each of the examples given above (i.e., velocity, acceleration, temperature, humidity, and operating voltage) satisfies this definition, since each is capable of remaining unchanged for a time interval, and is also capable of changing during a time interval. A condition such as an amount of elapsed time does not satisfy this requirement (and therefore is not herein considered to be one of the UE's environment conditions) because time is not capable of remaining static; it is always advancing. Consequently, time is not herein considered to be an environmental condition.

When the UE desires a TA update, it sends a TA uplink request in a synchronized fashion in the uplink. The Node B can use this TA request message to determine the timing misalignment in the uplink and to create a TA control message to be returned to this UE. If the UE does not receive a TA control message, loss of synchronization must be assumed. Loss of synchronization will result in additional delay and overhead since the UE has to carry out a random access procedure on the PRACH. This can be avoided by using the procedure as proposed herein, in which the UE itself takes action when loss of synchronization is imminent.

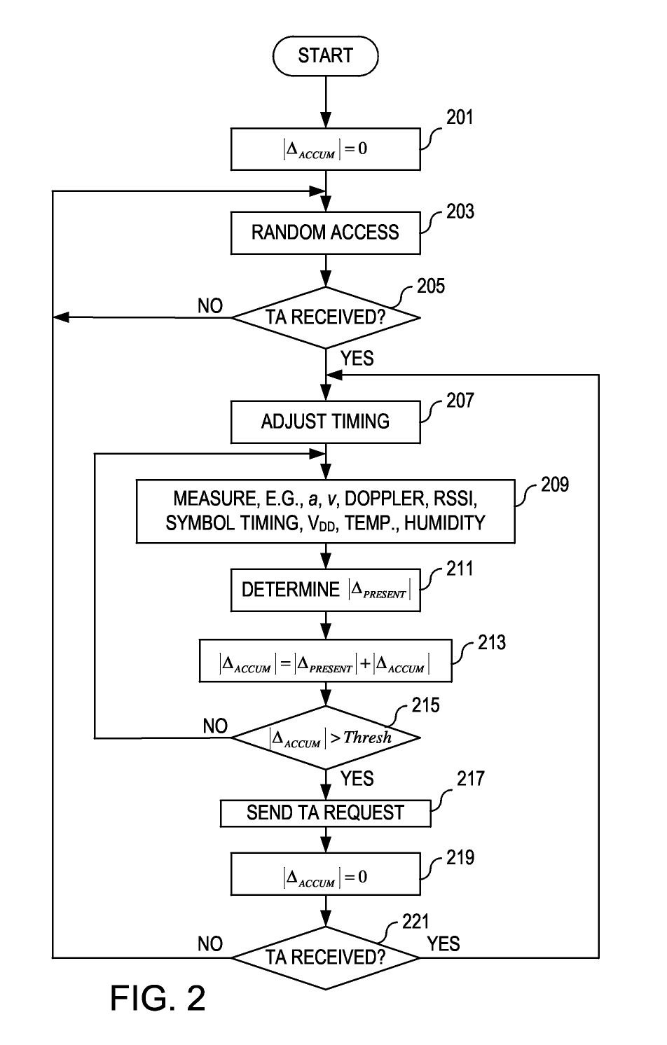

FIG. 2 is an exemplary embodiment of a method carried out in a UE in accordance with the invention. The method involves measuring one or more environmental conditions, and comparing each of the one or more measured values with a corresponding baseline value to derive a change metric representing an amount of change of that environmental condition. Only the magnitude of the change metric is considered (i.e., any sign associated with the change metric is disregarded). An accumulation metric, |Δ_{ACCUM}|, represents the combination (e.g., the sum) of all change metric magnitudes determined since a last timing advance update was performed. It will be observed that, in the exemplary embodiments described herein, the accumulation metric can only be a positive value, since it represents the sum of only positive values. Hence, it is herein represented as “|Δ_{ACCUM}|” to remind the reader of this. It is noted, however, that the invention does not require positive valued metrics. To the contrary, one could derive alternative embodiments in which all change metrics were considered to be negative (regardless of actual sign), with the result being that the accumulation metric would always be a negative value.

Thus, as part of initialization, the accumulation metric is set equal to zero (step 201).

To obtain initial timing synchronization, the UE performs a well-known random access procedure on the PRACH (step 203). Next, it determines whether a TA has been received from the Node B (decision block 205). If not (“NO” path out of decision block 205), then the UE repeats the random access procedure at step 203.

If a TA was received (“YES” path out of decision block 205), the UE adjusts its timing as instructed by the TA (step 207).

Now that the timing of the UE is synchronized with that of the Node B, the UE measures one or more of its environmental conditions, as discussed above (step 209). Such conditions may include, but are not limited to, acceleration (a), velocity (v), Doppler shift, RSSI, Symbol Timing, supply voltage (V_{DD}), temperature (Temp.), and humidity. In some embodiments, in addition to measuring the UE's environmental conditions, the elapsed time since the last TA update could also be tracked (not shown), since the passing of time also makes the clock values less reliable. In such embodiments, a TA request could be made in response to the elapsed time since the last TA update exceeding a predetermined amount of time (not shown).

Next, the UE determines a present value of a magnitude of change metric, |Δ_{PRESENT}|, by first comparing the value representing the measured environmental condition with a baseline value (step 211). The value obtained from this comparison is then converted to a magnitude by eliminating any sign associated with the value.

The baseline value can be determined differently for different types of environmental conditions. For example, since a non-zero Doppler shift means that the UE is moving relative to the source of the received signal, the baseline value is zero (i.e., the Doppler shift when the UE is at rest). For other types of environmental conditions (e.g., RSSI, Symbol Timing, supply voltage (V_{DD}), temperature (Temp.), and humidity), the baseline value is set equal to the measured value at the time of the last TA update.

The present magnitude of change metric, |Δ_{PRESENT}|, is then combined (e.g., summed) with the earlier-determined accumulation metric, |Δ_{ACCUM}|, to obtain a new accumulation metric (step 213).

Next, the UE determines whether its operating environment has changed sufficiently to make another timing adjustment desirable by comparing each accumulation metric, |Δ_{ACCUM}|, (only one shown in FIG. 2) with a corresponding threshold value (“Thresh”) (decision block 215). In the illustrated embodiment, the threshold value is a predetermined value that is considered to represent a maximum permissible accumulated amount of environmental change before another TA update will be required. That is, the accumulation metric can be considered to represent the extent to which the UE has been subjected to a changing environment, and the threshold value against which the accumulation metric is compared represents an amount of environmental change beyond which there is insufficient confidence in the accuracy of the clock. Thus, if the accumulation metric satisfies a predetermined relationship with the threshold (e.g., the accumulation metric is greater than the predetermined threshold), then the change is considered to be sufficient to make another timing adjustment desirable.

If the UE's operating environment has not changed sufficiently to make another timing adjustment desirable (“NO” path out of decision block 215), then operation of the UE returns to making more measurements at step 209.

However, if the UE's operating environment has changed sufficiently to make another timing adjustment desirable (“YES” path out of decision block 215), then the UE initiates the process by sending a TA request (step 217) to the Node B. Also, to prepare for a next cycle of measurement taking and analysis, the accumulation metric, |Δ_{ACCUM}|, is reinitialized (e.g., reset to zero) (step 219).

Next, the UE determines whether a TA has been received from the Node B (decision block 221). If not (“NO” path out of decision block 221), then the UE is presumed to be out of timing alignment with the Node B, and consequently repeats the random access procedure at step 203.

However, if a TA was received (“YES” path out of decision block 221), the UE adjusts its timing as instructed by the TA (step 207). The UE then begins monitoring its environmental conditions as before (step 209).

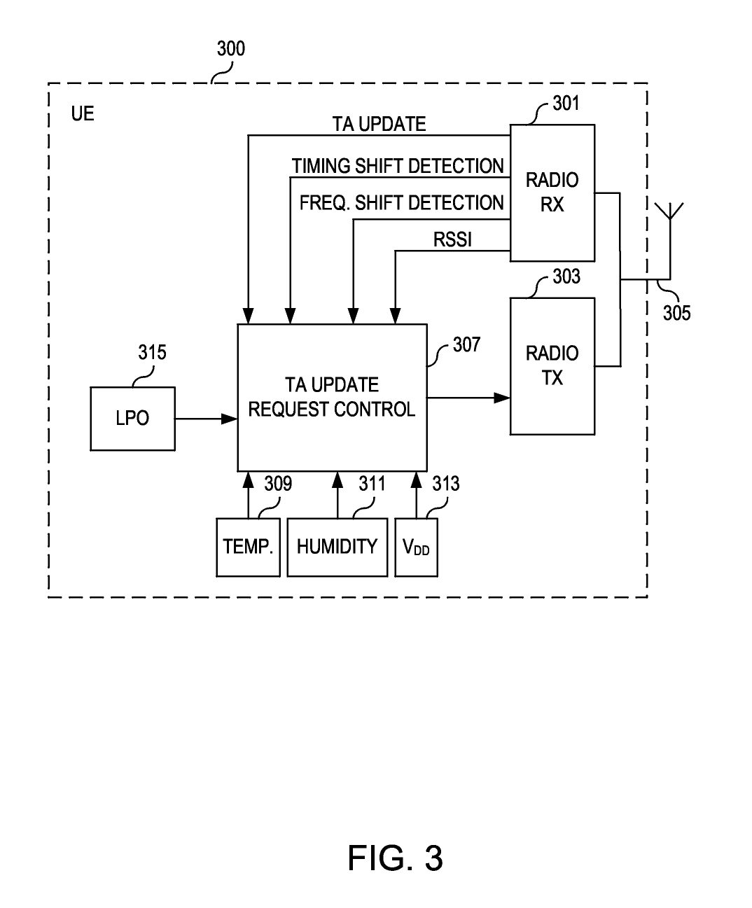

FIG. 3 is a block diagram of an exemplary embodiment of a UE 300 adapted to practice the invention. Only those elements relevant to understanding the invention are depicted. It will be understood, however, that the UE also includes other well-known elements (not shown) that contribute to making it a fully functional device.

The UE 300 includes a radio receiver 301 and a radio transmitter 303 that share an antenna 305. The UE 300 also includes a controller 307 that generates TA update requests by, for example, carrying out the process illustrated in FIG. 2. The TA update request is supplied to the transmitter 303 for transmission to the Node B.

To carry out the process, the controller 307 receives state information from a number of sources. In this example, the receiver 301 supplies the controller with any received TA message that has been received (including an indication of whether a TA message has been received), timing shift detection information, frequency shift detection information, and RSSI.

Information about the UE's temperature, humidity, and power supply are provided by respective temperature, humidity, and power supply sensors 309, 311, 313. A low power oscillator (LPO) 315 provides the controller 307 with the UE's present timing information. The low power oscillator 315 provides the reference for the uplink timing, and is very important in this discussion because changes in, for example, temperature humidity, and elapsed time affect its accuracy, which is why TA updates are necessary. Other well-known logic within the UE (not shown) is responsible for adjusting the UE's timing when a TA is received.

Embodiments that carry out the techniques described herein optimize the periodic timing alignment procedure both from a system view point and from a terminal view point. For UEs that operate under stable conditions, the interval between periodic timing updates can be rather long. For UEs whose local conditions vary heavily, the rate of TA updates is increased at the request of the UE. Since sending uplink transmissions for TA measurements and downlink transmissions for TA control messages introduces overhead in the system, which reduces the overall capacity, a system-wide advantage is obtained if only those UEs whose uplink timing is likely to change are actually controlled. Likewise, power consumption is improved for UEs in the low-power mode, since they are involved in the TA procedure at a higher refresh rate only when their local conditions change.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of operating a User Equipment (UE), comprising:
measuring an environmental condition of the UE;
determining a present magnitude of change metric representing a present magnitude of change of the environmental condition relative to a baseline value;
combining the present magnitude of change metric with a previous accumulation metric to obtain a present accumulation metric;
detecting whether the present accumulation metric satisfies a predetermined relationship with respect to a threshold value;
if it is detected that the present accumulation metric satisfies the predetermined relationship with respect to the threshold value, then transmitting a timing advance request.

2. The method of claim 1, wherein:
measuring the environmental condition comprises measuring a Doppler shift of a received signal; and
the baseline metric is zero.

3. The method of claim 1, wherein:
measuring the environmental condition comprises determining a Received Signal Strength Indication from a received signal; and
the baseline metric is a Received Signal Strength Indication value determined when a most recent timing advance update was performed.

4. The method of claim 1, wherein:
measuring the environmental condition comprises measuring a temperature within the UE; and
the baseline metric is a temperature value determined when a most recent timing advance update was performed.

5. The method of claim 1, wherein:
measuring the environmental condition comprises measuring a humidity within the UE; and
the baseline metric is a humidity value determined when a most recent timing advance update was performed.

6. The method of claim 1, wherein:
measuring the environmental condition comprises measuring a supply voltage of the UE; and
the baseline metric is a supply voltage value determined when a most recent timing advance update was performed.

7. The method of claim 1, wherein:
measuring the environmental condition comprises measuring a symbol timing of a received signal; and
the baseline metric is a symbol timing value determined when a most recent timing advance update was performed.

8. An apparatus for operating a User Equipment (UE), comprising:
logic adapted to measure an environmental condition of the UE;
logic adapted to determine a present magnitude of change metric representing a present magnitude of change of the environmental condition relative to a baseline value;
logic adapted to combine the present magnitude of change metric with a previous accumulation metric to obtain a present accumulation metric;
logic adapted to detect whether the present accumulation metric satisfies a predetermined relationship with respect to a threshold value;
logic adapted to transmit a timing advance request in response to it being detected that the present accumulation metric satisfies the predetermined relationship with respect to the threshold value.

9. The apparatus of claim 8, wherein:
the logic adapted to measure the environmental condition comprises logic adapted to measure a Doppler shift of a received signal; and
the baseline metric is zero.

10. The apparatus of claim 8, wherein:
the logic adapted to measure the environmental condition comprises logic adapted to determine a Received Signal Strength Indication from a received signal; and
the baseline metric is a Received Signal Strength Indication value determined when a most recent timing advance update was performed.

11. The apparatus of claim 8, wherein:
the logic adapted to measure the environmental condition comprises logic adapted to measure a temperature within the UE; and
the baseline metric is a temperature value determined when a most recent timing advance update was performed.

12. The apparatus of claim 8, wherein:
the logic adapted to measure the environmental condition comprises logic adapted to measure a humidity within the UE; and
the baseline metric is a humidity value determined when a most recent timing advance update was performed.

13. The apparatus of claim 8, wherein:
the logic adapted to measure the environmental condition comprises logic adapted to measure a supply voltage of the UE; and
the baseline metric is a supply voltage value determined when a most recent timing advance update was performed.

14. The apparatus of claim 8, wherein:
logic adapted to measure the environmental condition comprises logic adapted to measure a symbol timing of a received signal; and
the baseline metric is a symbol timing value determined when a most recent timing advance update was performed.
